(19) United States
(12) Patent Application Publication
(10) Pub. No.: US 2017/0268740 A1
(43) Pub. Date: Sep. 21, 2017

(54) RETROFIT LAMP AND VEHICLE HEADLIGHT WITH RETROFIT LAMP

(71) Applicant: OSRAM GmbH, Munich (DE)

(72) Inventor: Michael Boenigk, Berlin (DE)

(21) Appl. No.: 15/448,661

(22) Filed: Mar. 3, 2017

(30) Foreign Application Priority Data
Mar. 15, 2016 (DE) 10 2016 204 181.9

(51) Int. Cl. F21S 8/10

(52) U.S. Cl. CPC F21S 48/1241; F21S 48/1323; F21S 48/115; F21Y 2115/10

(57) ABSTRACT

In various embodiments, a retrofit lamp for vehicle headlights is provided. The retrofit lamp includes at least one semiconductor light source, a light output coupling optical unit, and a light guide configured to guide light from the at least one semiconductor light source to the light output coupling optical unit. The light output coupling optical unit has a light-reflecting embodiment and includes a first end and a second end. The first end is arranged closer to the at least one semiconductor light source than the second end. The light output coupling optical unit, proceeding from the second end, has a tapering embodiment in the direction of the first end.

### CROSS-REFERENCE TO RELATED APPLICATION

This application claims priority to German Patent Application Serial No. 10 2016 204 181.9, which was filed Mar. 15, 2016, and is incorporated herein by reference in its entirety.

### TECHNICAL FIELD

Various embodiments relate generally to a retrofit lamp for a vehicle headlight and a vehicle headlight including a retrofit lamp.

### BACKGROUND

The phrase retrofit lamp denotes a lamp which includes one or more semiconductor light sources as a light source and which includes a base which is compatible to a base of an incandescent lamp or a discharge lamp such that the retrofit lamp, as a replacement for an incandescent lamp or a discharge lamp, may be inserted into, and operated in, a socket of a lamp corresponding to the base.

In particular, a retrofit lamp for vehicle headlights may be inserted into a socket of a vehicle headlight and operated as a vehicle headlight lamp because it includes a base which is compatible with the base of an incandescent lamp or discharge lamp embodied as a vehicle headlight lamp.

### SUMMARY

In various embodiments, a retrofit lamp for vehicle headlights is provided. The retrofit lamp includes at least one semiconductor light source, a light output coupling optical unit, and a light guide configured to guide light from the at least one semiconductor light source to the light output coupling optical unit. The light output coupling optical unit has a light-reflecting embodiment and includes a first end and a second end. The first end is arranged closer to the at least one semiconductor light source than the second end. The light output coupling optical unit, proceeding from the second end, has a tapering embodiment in the direction of the first end.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a schematic illustration of the arrangement of semiconductor light sources, light guide and light output coupling optical unit of the retrofit lamp in accordance with the first embodiment;

FIG. 2 shows a schematic, partly cut illustration of the retrofit lamp in accordance with the first embodiment;

FIG. 3 shows a schematic, partly cut illustration of the base of the retrofit lamp in accordance with the first exemplary embodiment;

FIG. 4 shows a magnified, schematic illustration of the light output coupling optical unit and a portion of the light guide of the retrofit lamp depicted in the FIG. 1 to FIG. 3, in accordance with the first embodiment;

FIG. 5 shows a schematic illustration of the arrangement of semiconductor light sources, light guide and light output coupling optical unit of the retrofit lamp in accordance with the second embodiment;

FIG. 6 shows a schematic illustration of the arrangement of semiconductor light sources, light guide and light output coupling optical unit of the retrofit lamp in accordance with the third embodiment; and

FIG. 7 shows a schematic, partly cut illustration of a vehicle headlight including the retrofit lamp depicted in FIG. 2.

### DESCRIPTION

The following detailed description refers to the accompanying drawings that show, by way of illustration, specific details and embodiments in which the invention may be practiced.

Various embodiments provide a retrofit lamp which is compatible with a vehicle headlight lamp embodied as a high-pressure discharge lamp and usable as a replacement for such a lamp in a vehicle headlight.

The retrofit lamp according to various embodiments is provided as a light source for vehicle headlight and includes at least one semiconductor light source, a light output coupling optical unit embodied in a light-reflecting manner and a light guide which is embodied to guide light from the at least one semiconductor light source to the light output coupling optical unit. The light output coupling optical unit includes a first end and a second. The first end is arranged closer to the at least one semiconductor light source than the second end. The light output coupling optical unit, proceeding from the second end thereof, has an embodiment which tapers in the direction of the first end thereof.

On account of the aforementioned features, the retrofit lamp according to various embodiments produces a light distribution during the operation thereof, said light distribution substantially corresponding to the light distribution of a high-pressure discharge lamp for vehicle headlight. Therefore, the retrofit lamp according to various embodiments may be used as a replacement for a vehicle headlight lamp embodied as a high-pressure discharge lamp. By way of example, the retrofit lamp according to various embodiments may be inserted into, and used in, an appropriate vehicle headlight as a light source instead of a high-pressure discharge lamp of ECE category D1S, D2S, D3S or D4S.

With the aid of the light guide, the light produced by the at least one semiconductor light source is guided to the light output coupling optical unit with a light-reflecting embodiment of the retrofit lamp according to various embodiments and there it is reflected in different directions. A light distribution substantially corresponding to the light distribution of a vehicle headlight lamp embodied as a high-pressure discharge lamp is produced with the aid of the light output coupling optical unit, embodied in a light-reflecting manner, of the retrofit lamp according to various embodiments.

In various embodiments, the tapering embodiment of the light-reflecting light output coupling optical unit facilitates an emission of the light without reflection back into the light guide. As a result of the tapering embodiment of the light-reflecting light output coupling optical unit, the light guided in the light guide is reflected in different directions and, for example, also deflected from the axis of longitudinal extent of the light guide.

In various embodiments, the light output coupling optical unit of the retrofit lamp according to various embodiments has a mirror symmetrical embodiment in respect of a plane containing a longitudinal axis of the light output coupling optical unit, wherein the longitudinal axis of the light output coupling optical unit extends centrally through the first end and the second end of the light output coupling optical unit. Additionally, the light guide of the retrofit lamp according to various embodiments may also have the same mirror symmetry as the light guide optical unit.

The light output coupling optical unit of the retrofit lamp according to various embodiments may have a rotational symmetric embodiment in respect of an axis of rotational symmetry and a minimum diameter at the first end thereof. The diameter at the first end of the light output coupling optical unit is as small as possible. Additionally, the light guide of the retrofit lamp according to various embodiments may also have a rotationally symmetric embodiment.

In accordance with one embodiment of the retrofit lamp according to various embodiments, the light output coupling optical unit thereof includes at least one cone-like or frustum-like portion. In addition to a cone-shaped portion of the light output coupling optical unit, the term cone-like portion of the light output coupling optical unit also includes those modifications of the cone-shaped portion of the light output coupling optical unit which are formed by one or more depressions or elevations in the lateral cone surface. In various embodiments, this also includes a portion of the light output coupling optical unit with a concavely or convexly arched lateral cone surface, in which the lateral area is produced by rotating a concavely or convexly arched curve about the cone axis. That is to say, the lateral area is formed by a concavely or convexly arched curve in a longitudinal section through the cone containing the cone axis, said curve connecting the cone tip to an edge point of the cone base area. Additionally, the term cone-like portion of the light output coupling optical unit also includes those modifications of the cone-shaped portion of the light output coupling optical unit, in which, in cross-sections perpendicular to the cone axis through the portion of the light output coupling optical unit, the lateral area is formed in each case by a regular polygon, wherein circumference and the area of the polygon reduce in the direction of the second end of the light output coupling optical unit and the number of corners of the regular polygon remains unchanged. The lateral area and the corresponding portion of the light output coupling optical unit have an n-fold rotational symmetry about a longitudinal axis extending perpendicular to the base area and through the cone tip of the cone-like portion of the light output coupling optical unit as a result thereof, where n denotes the number of corners of the regular polygon. The term n-fold rotational symmetry means that the cone-like portion of the light output coupling optical unit is invariant in relation to rotations with an angle of 360°/n about the longitudinal axis thereof. In various embodiments, n is greater than or equal to 12. The surface or the lateral area of the cone-like portion of the light output coupling optical unit has a light-reflecting embodiment.

In addition to a frustum-shaped portion of the light output coupling optical unit, the term frustum-like portion of the light output coupling optical unit also analogously includes those modifications of the frustum-shaped portion of the light output coupling optical unit which are formed by one or more depressions or elevations in the lateral frustum surface. In various embodiments, this also includes a portion of the light output coupling optical unit with a concavely or convexly arched lateral frustum surface, in which the lateral area is produced by rotating a concavely or convexly arched curve about the frustum axis. That is to say, the lateral area is formed by a concavely or convexly arched curve in a longitudinal section through the frustum containing the frustum axis, said curve connecting an edge point of the top area of the frustum to an edge point of the base area of the frustum. Additionally, the term frustum-like portion of the light output coupling optical unit also includes those modifications of the frustum-shaped portion of the light output coupling optical unit, in which, in cross-sections perpendicular to the frustum axis through the corresponding portion of the light output coupling optical unit, the lateral area is formed in each case by a regular polygon, wherein the circumference and the area of the polygon reduce in the direction of the second end of the light output coupling optical unit and the number of corners of the regular polygon remains unchanged. The lateral area and the corresponding portion of the light output coupling optical unit have an n-fold rotational symmetry about a longitudinal axis oriented perpendicular to the base area and top area of the frustum-like portion of the light output coupling optical unit and extending centrally through the base area and top area of the frustum-like light output coupling optical unit as a result thereof, where n denotes the number of corners of the regular polygon. The term n-fold rotational symmetry means that the frustum-like light output coupling optical unit is invariant in relation to rotations with an angle of 360°/n about the longitudinal axis thereof. In various embodiments, n is greater than or equal to 12. The surface or the lateral area of the frustum-like light output coupling optical unit has a light-reflecting embodiment.

Advantageously, at least the first end of the light output coupling optical unit, which has a tapered embodiment in comparison with the second end thereof, is embedded in the material of the light guide. As a result, fixing and holding the light output coupling optical unit in the light guide is facilitated in a simple manner.

The light output coupling optical unit may be formed by a cavity with a funnel-like form in the light guide in the retrofit lamp according to various embodiments, wherein surfaces delimiting the cavity have a light-reflecting embodiment. As a result, the light output coupling optical unit may be combined with the light guide in a simple and space-saving manner.

Alternatively, the light coupling optical unit of the retrofit lamp according to various embodiments may consist of metal or a material with a similarly high degree of reflection.

In various embodiments, the light output coupling optical unit of the retrofit lamp according to various embodiments is arranged at a light-exit end of the light guide. As a result, the light emitted by the at least one semiconductor light source may be guided largely without losses to the light-reflecting light output coupling optical unit by means of the light guide.

The light guide of the retrofit lamp according to various embodiments may have a rod-like embodiment in order to facilitate short light guidance from the at least one semiconductor light source to the light output coupling optical unit. In various embodiments, the light guide is embodied as an optical waveguide which guides light by means of total internal reflection from a light-entrance end of the light guide to a light-exit end of the light guide.

The light guide of the retrofit lamp according to various embodiments consists of transparent material, e.g. a glass or a transparent plastic, in order to largely avoid light absorption in the light guide material.

The retrofit lamp according to various embodiments may include a base which defines a reference plane for aligning the light output coupling optical unit. As a result, aligning the light output coupling optical unit of the retrofit lamp according to various embodiments in respect of an optical axis of a reflector of the vehicle headlight is facilitated when said retrofit lamp is used in the vehicle headlight.

In various embodiments, the axis of rotational symmetry of the light output coupling optical unit of the retrofit lamp according to various embodiments is aligned perpendicular to the reference plane. This ensures that the axis of rotational symmetry of the light output coupling optical unit is aligned parallel to the optical axis of the reflector of the vehicle headlight when installing the retrofit lamp according to various embodiments in the vehicle headlight.

In various embodiments, the distance between the first end of the light output coupling optical unit and the reference plane of the base is less than a value E and the distance between the second end of the light output coupling optical unit and the reference plane of the base is greater than or equal to the value E in the retrofit lamp according to various embodiments, wherein the value E is either 27.1 mm or 18.0 mm. This ensures that the light output coupling optical unit of the retrofit lamp is placed at the same location where the electric arc of the employed high-pressure discharge lamp was placed when a high-pressure discharge lamp of ECE category D1R, D1S, D2R, D2S, D3R, D3S, D4R, D4S, D5S, D6S, D8R, D8S or D9S, embodied as a vehicle headlight lamp, is replaced by a retrofit lamp according to various embodiments. The value E is 18.0 mm for a retrofit lamp according to various embodiments for replacing a high-pressure discharge lamp of ECE category D5S and the value E is 27.1 mm for a retrofit lamp according to various embodiments for replacing a high-pressure discharge lamp of one of the other aforementioned ECE categories.

The base of the retrofit lamp according to various embodiments may have a base housing, in which the at least one semiconductor light source is arranged. As a result, the at least one semiconductor light source is protected from contact and damage and, moreover, a direct light emission of the retrofit lamp without detour via the light guide and light output coupling optical unit is prevented. The base housing shadows light which is emitted by the at least one semiconductor light source and which is not coupled into the light guide.

In various embodiments, one end of the light guide of the retrofit lamp according to various embodiments is arranged in the base housing in order to protect the light-entrance end of the light guide, into which the light produced by the at least one semiconductor light source is coupled, from contact and damage.

The at least one semiconductor light source of the retrofit lamp according to various embodiments may be arranged on an assembly circuit board. This facilitates a simple assembly and electrical contacting of the at least one semiconductor light source. In various embodiments, additional electronic components of an operating circuit for the at least one semiconductor light source may be arranged on the assembly circuit board and connected to the at least one semiconductor light source, for example by way of conductor tracks likewise arranged on the assembly circuit board. The assembly circuit board may be arranged in the base housing of the retrofit lamp according to various embodiments.

In various embodiments, the light guide of the retrofit lamp according to various embodiments is fixed to the assembly circuit board or to the base by means of a holder. This facilitates fixing the light guide and the light output coupling optical unit of the retrofit lamp according to various embodiments, connected to the light guide, to the base or to the assembly printed circuit board, and adjusting the light output coupling optical unit in respect of the reference plane of the base.

The retrofit lamp according to various embodiments may include a cooling body for the at least one semiconductor light source in order to dissipate heat produced by the at least one semiconductor light source and the operating circuit thereof to the outside. The cooling body may be thermally coupled to the assembly printed circuit board on which the at least one semiconductor light source and the operating circuit thereof are arranged. The cooling body is preferably equipped with cooling ribs, arranged outside of the base housing, in order to ensure ideal cooling.

The retrofit lamp according to various embodiments may include a converging lens apparatus arranged between the at least one semiconductor light source and a light-entrance end of the light guide in order to ensure efficient light input coupling of the light emitted by the at least one semiconductor light source into the light guide.

The at least one semiconductor light source of the retrofit lamp according to various embodiments may be embodied as a white-light-emitting light-emitting diode. Alternatively, the at least one semiconductor light source may also be embodied as a laser diode which produces and emits blue light during operation, said blue light being converted in portions thereof into light with a different wavelength, e.g. light from the yellow spectral range, by means of a phosphor element such that a mixture of non-converted laser light and converted light yielding white light is produced at the phosphor element. The phosphor element may be arranged at the light-entrance end or at the light-exit end of the light guide or embodied as a coating of the surface of the light output coupling optical unit.

In various embodiments, the retrofit lamp according to various embodiments includes a plurality of light-emitting diodes arranged in rows and columns, said diodes producing white light during operation, the white light being coupled into the light-entrance end of the light guide by means of a converging lens apparatus in order to produce white light with a high brightness and luminance.

The retrofit lamp according to various embodiments may be used in a vehicle headlight, for example for producing a dimmed beam, a high beam or further light functions such as e.g. a fog light and a position light etc.

The retrofit lamp according to various embodiments may be used as a light source in any type of vehicle.

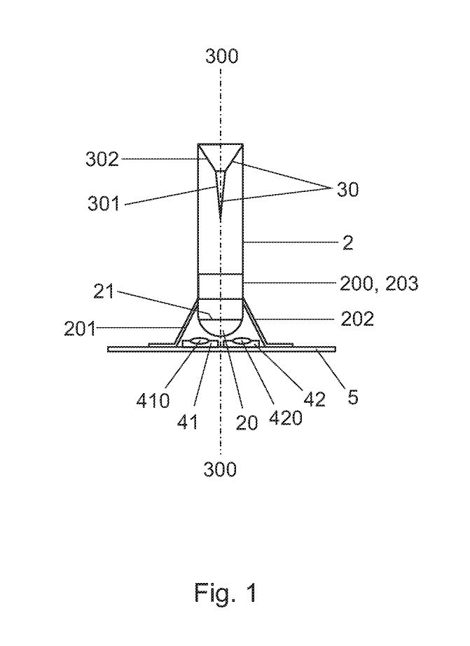

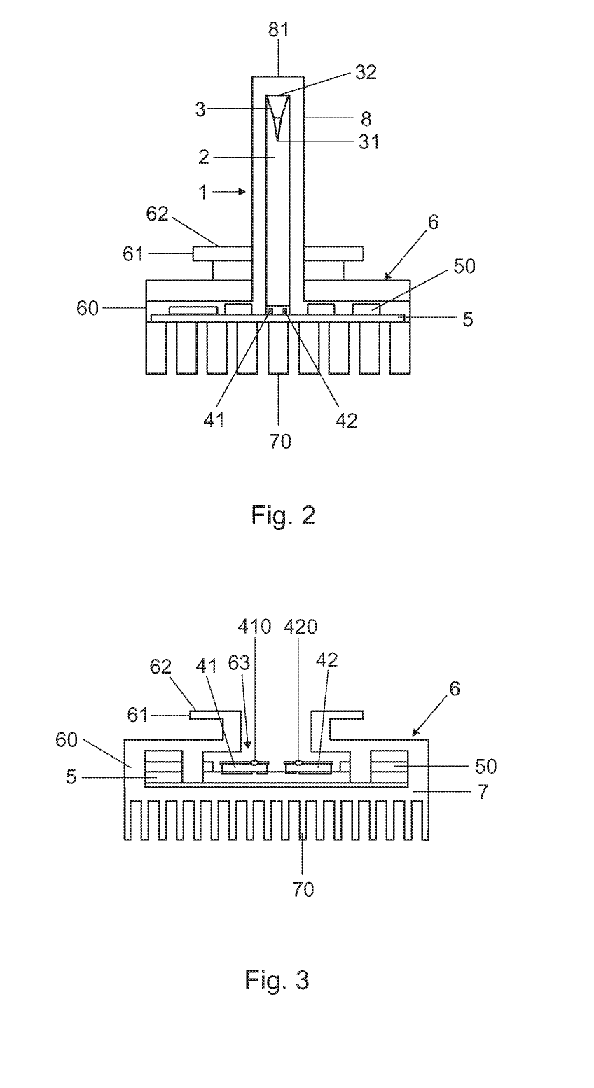

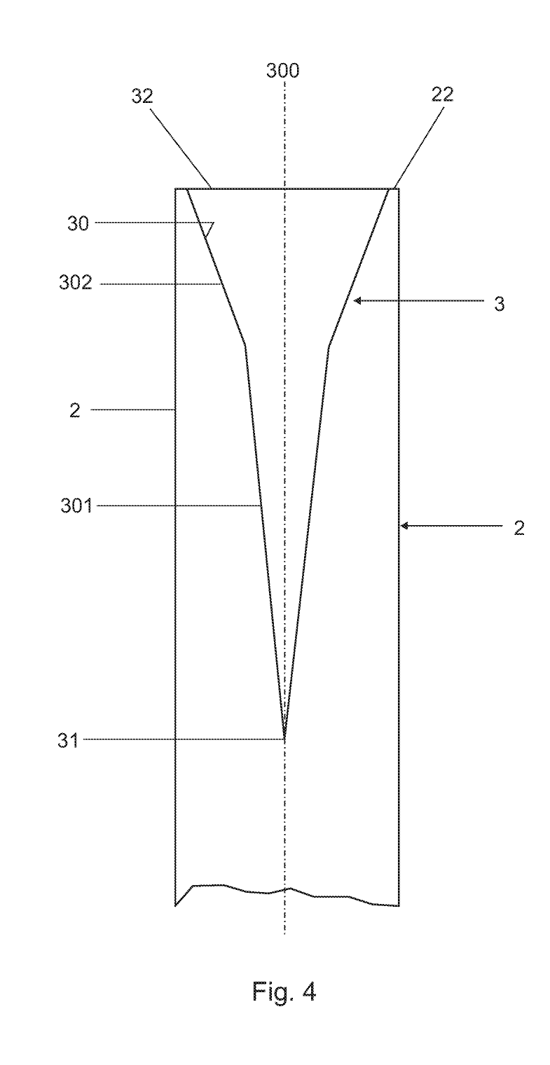

FIG. 1 to FIG. 4 schematically depict details of a retrofit lamp 1 in accordance with the first embodiment. The retrofit lamp 1 in accordance with the first embodiment serves as a light source in a vehicle headlight and is used, for example, for producing a high beam or a dimmed beam or, for example, for both aforementioned light distributions. In various embodiments, the retrofit lamp 1 is compatible with a high-pressure discharge lamp of ECE categories D1s, D2s, D3s and D4s, and may therefore be used as a replacement for such a high-pressure discharge lamp in a vehicle headlight.

The retrofit lamp 1 in accordance with the first embodiment includes six semiconductor light sources 410, 420, a converging lens apparatus 20, a light guide 2, a holder 200 for the light guide, a light output coupling optical unit 3, an assembly circuit board 5 for the semiconductor light sources and for components 50 of a circuit arrangement for operating the semiconductor light sources, a base 6, a cooling body 7 and a lamp vessel 8.

The semiconductor light sources of the retrofit lamp 1 in accordance with the first embodiment are embodied as two LED chips 41, 42, which each have three light-emitting diodes 410 and 420, respectively, arranged in a row. The two LED chips 41, 42 are affixed next to one another on the assembly circuit board 5 such that the semiconductor light sources 410, 420 of the two LED chips 41, 42 are arranged in two parallel rows and three parallel lines on the surface of the assembly circuit board 5. The total of six semiconductor light sources 410, 420 are each embodied as light-emitting diodes which emit white light during operation. By way of example, the LED chips 41, 42 are embodied in a chip-on-board configuration in order to ensure a compact design. The LED chips 41, 42 may be operated with DC current, for example with pulse-width modulated DC current. This allows the light output to be matched to the requirements. In various embodiments, this allows e.g. an increase in the light output in the case of rain. Here, the light-emitting diodes 410, 420 may be actuated individually or in groups.

The assembly circuit board 5 is embodied as an IMS printed circuit board. The abbreviation IMS denotes an “insulated metal substrate”. Components 50 of a circuit arrangement for operating the LED chips 41, 42 are additionally arranged on the assembly circuit board 5 and electrically contacted by conductor tracks likewise present on the assembly circuit board 5.

The base 6 includes a base housing 60, in the interior of which the assembly circuit board 5 with the LED chips 41, 42 and components 50 of the operating circuit assembled thereon is housed. A bottom of the base housing 60 is embodied as a metallic cooling body 7 which is thermally coupled to the LED chips 41, 42 and the components 50 of the operating circuit. The assembly printed circuit board 5 is fixed to the bottom of the base housing 60 and hence to the cooling body 7. The cooling body 7 includes cooling ribs 70, which are arranged outside of the interior of the base housing 60 on the bottom of the base housing 60. On a top side lying opposite the bottom, the base housing 60 includes a ring-shaped base flange 61 which serves to assemble the retrofit lamp 1 in the socket of a vehicle headlight. The top side of the base housing 60 has a perforation 63 in the region of the base flange 61. The base 6 includes a reference plane 62 which is defined by a ring-disk-shaped surface of the base flange 61 on the outer side of the base housing 60.

The light guide 2 has an embodiment that is analogous to an optical waveguide and consists of a transparent material, for example quartz glass or a transparent plastic. It includes a core and cladding, wherein the core consists of e.g. pure quartz glass and the cladding consists of e.g. doped quartz glass such that the cladding of the light guide 2 has a lower optical refractive index than the core thereof. Alternatively, the light guide 2 may also consist of transparent silicone. The light guide 2 has a rigid and rod-like, e.g. circular cylindrical, embodiment and includes a light-entrance end 21, which faces the surface of the assembly circuit board 5 and the LED chips 41, 42, and a second end 22, which faces away from the LED chips 41, 42 and on which the light output coupling optical unit 3 is arranged. The diameter of the light guide is 3.5 mm. The light guide 2 is fastened to the assembly circuit board 5 by means of the holder 200 and aligned approximately perpendicular to the surface of the assembly circuit board 5. The light guide 2 protrudes from the base housing 60 through the perforation 63.

A converging lens apparatus 20 which collects light emitted by the light-emitting diodes 410, 420 of the LED chips 41, 42 and focuses said light onto the light-entrance end 21 is arranged in the region between the two LED chips 41, 42 and the light-exit end 22 of the light guide 2. The converging lens apparatus 20 is only depicted schematically in FIG. 1. It may consist of a system of a plurality of optical elements. However, it may be realized by convex arching of the light-entrance end 21 of the light guide 2.

The holder 200 of the light guide 2 includes a metallic fastening ring 203 which surrounds the light guide 2 with a press fit, and at least two metallic fastening straps 201, 202, which are in each case welded to the fastening ring 203 at one end and fastened to the assembly printed circuit board 5 with the other end thereof.

The light output coupling optical unit 3 is formed by a funnel-like cavity in the light guide 2 which, proceeding from the second end 22 of the light guide 2, extends in the direction of its light-entrance end 21 and which is delimited by a light-reflecting surface 30. The surface 30 has a metallic coating in order to ensure a high degree of light reflection. The light output coupling optical unit 3 has a rotationally symmetric embodiment in respect of an axis of rotational symmetry 300. It includes a first end 31 and a second end 32, wherein the first end 31 of the light output coupling optical unit 3 is arranged closer to the LED chips 41, 42 than the second end 32 thereof, and wherein the first end 31 has a tapered embodiment in relation to the second end 32 of the light output coupling optical unit 3. The funnel-like light output coupling optical unit 3 is formed by a first, cone-shaped portion 301 and a second, immediately adjoining frustum-like portion 302. The cone tip of the first portion 301 is formed by the first end 31 of the light output coupling optical unit 3 and the second end 32 of the light output coupling optical unit 3 is formed by the frustum-like second portion 302 thereof. The second, frustum-like portion 302 of the light output coupling optical unit 3 terminates with the second end 22 of the light guide 2 and is arranged in such a way that the diameter of the light output coupling optical unit 3, proceeding from the second end 32 thereof, continuously reduces up to the first end 31 thereof. The height of the light output coupling optical unit 3, i.e. the distance between the first end 31 and the second end 32 of the light output coupling optical unit 3, is 4 mm. The axis of rotation of symmetry 300 of the light output coupling optical unit 3 is identical to the longitudinal or cylindrical axis of the light guide 2. The position and orientation of the light output coupling optical unit 3 are aligned in respect of the reference plane 62 of the base 6. In particular, the axis of rotational symmetry 300 of the light output coupling optical unit 3 is aligned perpendicular to the reference plane 62 of the base 6. The distance of the first end 31 of the light output coupling optical unit 3 from the reference plane 62 is 25.1 mm and the distance of the second end 32 of the light output coupling optical unit 3 from the reference plane 62 is 29.1 mm. The axis of rotational symmetry 300 of the light output coupling optical unit 3 is aligned in relation to the reference plane 62 of the base 6 in such a way that it is identical to the optical axis of the vehicle headlight reflector after the retrofit lamp has been installed into the vehicle headlight. Alternatively, the axis of rotational symmetry 300 of the light output coupling optical unit 3 may be aligned in relation to the reference plane 62 of the base 6 in such a way that, after the installation of the retrofit lamp in the vehicle headlight, it is arranged above the optical axis of the vehicle headlight reflector with at most 1 mm parallel offset to the optical axis of the vehicle headlight reflector in order to simulate upward curvature of the electric arc of a high-pressure discharge lamp caused by convection.

The lamp vessel 8 has a tube-shaped, e.g. hollow cylindrical embodiment, consists of glass or a transparent plastic and is arranged coaxially in relation to the light guide 2 and the light output coupling optical unit 3. The lamp vessel 8 is fastened with a press fit to the edge of the perforation 63 on the base housing and surrounds the portion of the light guide 2 projecting from the base housing 60 and the light output coupling optical unit 3. The lamp vessel 8 serves to protect the light guide 2 and the light output coupling optical unit 3 from contact and damage. The end 81 of the lamp vessel 8 which protrudes out of the perforation 63 of the base housing 60 and projects beyond the light output coupling optical unit 3 is sealed in order to prevent the ingress of dirt into the lamp vessel 8. By way of example, the interior of the lamp vessel 8 is evacuated or filled with gas or a gas mixture. By way of example, the filling gas or filling gas mixture contains air or an inert gas or a mixture of air and an inert gas, wherein nitrogen, SF₆ and noble gases and mixtures thereof may be provided as an inert gas.

White light which is coupled into the light-entrance end 21 of the light guide 2 by means of the converging lens apparatus 20 is produced by the light-emitting diodes 410, 420 during the operation of the retrofit lamp 1. In the interior of the light guide 2, the coupled-in light is guided to the light-exit end 22 of the light guide 2 by total internal reflection at the cladding of the light guide 2. In the region of the light output coupling optical unit 3, the light guided in the interior of the light guide 2 is reflected back into the light guide 2 when it is incident on the metallized surface 30, and so some of this light is incident on the lateral area 23 of the light guide 2 at an angle which is smaller than the angle of total-internal reflection, and hence it leaves the light guide 2 via the lateral area 23 thereof. A further part of the light emitted by the semiconductor light sources 410, 420 leaves the light guide 2 by way of the second end 22 thereof, which is therefore also referred to as light-exit end 22 of the light guide 2. The light which is produced by the light-emitting diodes 410, 420 and coupled into the light guide 2 is substantially emitted level with the light output coupling optical unit 3 by way of the lateral area 23 of the light guide 2 and by way of the light-exit end 22 of the light guide 2.

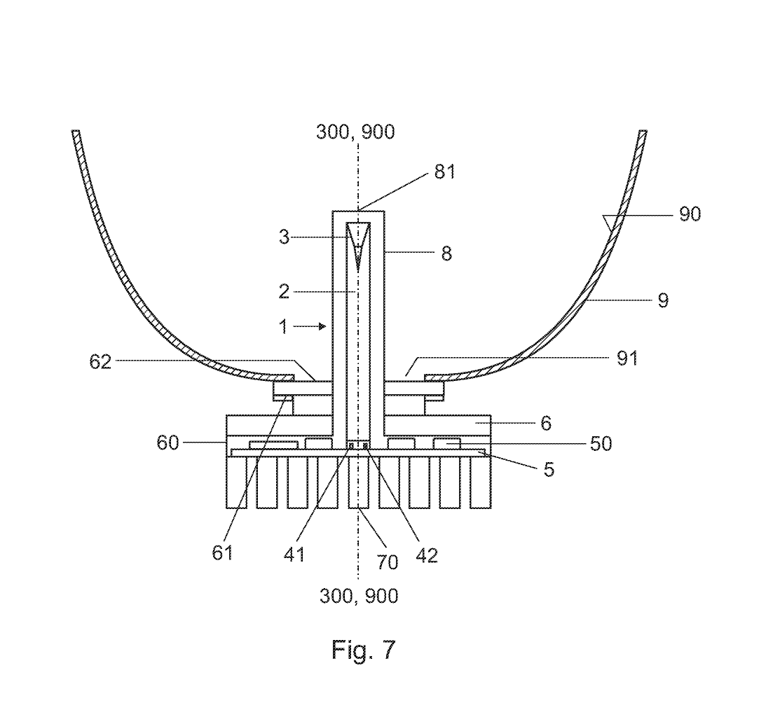

FIG. 7 depicts, schematically and partly cut, a vehicle headlight including a retrofit lamp 1 in accordance with the first embodiment. The vehicle headlight includes a reflector 9 with a light-reflecting reflection area 90 and optical axis 900. By way of example, the reflection area 90 is embodied as a parabola or with an ellipsoid shape or as a free-form surface. The retrofit lamp 1 is fastened by means of the base flange 61 thereof in an assembly opening 91 of the reflector 9. The base 6 or the base flange 61 of the retrofit lamp 1 and the assembly opening 91 of the reflector 9 or of the vehicle headlight have fastening means (not depicted here) which are matched to one another and which ensure that the retrofit lamp 1 is fixed in the reflector 9 such that the longitudinal axis or axis of rotational symmetry 300 of the light output coupling optical unit 3 of the retrofit lamp 1 lies in the optical axis 900 of the reflector 9. The reference plane 62 adjoins on the outer side of the reflector 9.

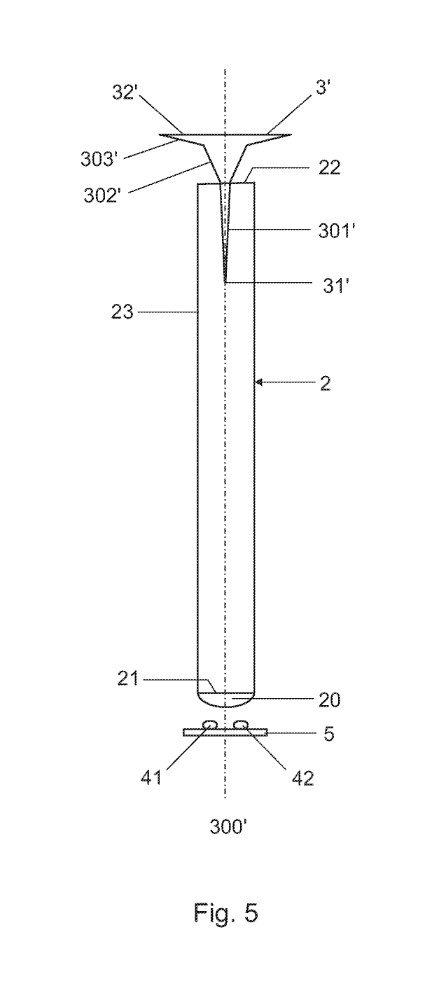

FIG. 5 schematically depicts the arrangement of the semiconductor light sources 41, 42 of the light guide 2 and of the light output coupling optical unit 3′ of a retrofit lamp 1 in accordance with the second embodiment. The retrofit lamp 1 in accordance with the second embodiment differs from the retrofit lamp in accordance with the first embodiment only in a different design of the light output coupling optical unit 3′. Therefore, only the light output coupling optical unit 3′ of the retrofit lamp in accordance with the second embodiment is described in more detail below and reference is made to the description of the corresponding components of the retrofit lamp in accordance with the first embodiment for the description of the other components of the retrofit lamp in accordance with the second embodiment.

The light output coupling optical unit 3′ has a rotationally symmetric embodiment in respect of an axis of rotational symmetry 300′ and consists of a metal, for example aluminum. It includes a conical first portion 301′ and a frustum-shaped second portion 302′ adjoining the first portion 301′, and a third portion 303′, which adjoins the second portion 302′ and likewise has a frustum-shaped embodiment. The conical first portion 301′ of the light output coupling optical unit 3′ is surrounded by the material of the light guide 2. The immediately adjoining second portion 302′ of the light output coupling optical unit 3′ protrudes from the second end 22 of the light guide 2. The cone tip of the first portion 301′ forms a first end 31′, facing the semiconductor light sources 41, 42, of the light output coupling optical unit 3′ and the third portion 303′ forms a second end 32′, facing away from the semiconductor light sources 41, 42, of the light output coupling optical unit 3′. The axis of rotational symmetry 300′ of the light output coupling optical unit 3′ lies in the cylindrical axis of the light guide 2. Proceeding from the cone tip 31′, the diameter of the light output coupling optical unit 3′ increases continuously in the direction of the second end 32′.

Light which is emitted by the semiconductor light sources 41, 42 and coupled into the light guide 2 by way of the converging lens apparatus 20 at the light-entrance end 21 is partly reflected at the cone-shaped first portion 301′ of the light output coupling optical unit 3′ such that it leaves the light guide 2 level with the first portion 301′ by way of the lateral area 23 of the light guide 2. A further part of the light leaves the light guide 2 by way of the light-exit end 22 thereof and is reflected at the second or third frustum-shaped portion 302′ or 303′ of the light output coupling optical unit 3′ and deflected in different directions.

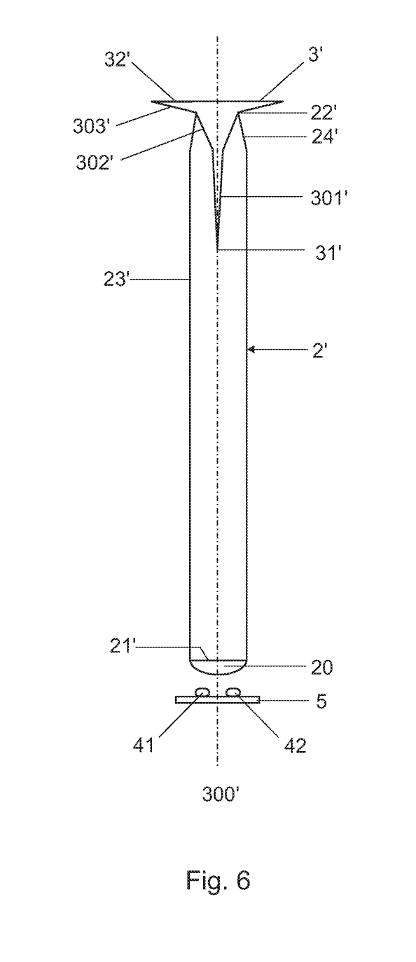

FIG. 6 schematically depicts the arrangement of the semiconductor light sources 41, 42 of the light guide 2 and of the light output coupling optical unit 3′ of a retrofit lamp 1 in accordance with the third embodiment. The retrofit lamp 1 in accordance with the third embodiment differs from the retrofit lamp in accordance with the second embodiment only in a different design of the light guide 2. Therefore, only the light guide 2′ of the retrofit lamp in accordance with the third embodiment is described in more detail below and reference is made to the description of the corresponding components of the retrofit lamp in accordance with the first and second embodiment for the description of the other components of the retrofit lamp in accordance with the third embodiment.

The light guide 2′ of the retrofit lamp in accordance with the third embodiment differs from the light guide 2 in accordance with the second embodiment only in that the light guide 2′ of the retrofit lamp in accordance with the third embodiment of the invention has a conically formed light guide portion 24′ at the second end 22′ thereof, the external diameter of said conically formed light guide portion reducing in the direction of the second end 22′. Moreover, the frustum-shaped second portion 302′ of the light output coupling optical unit 3′ is embedded in the material of the conically formed light guide portion 24′. The frustum-shaped third portion 303′ of the light output coupling optical unit 3′ protrudes from the second end 22′ of the light guide 2′. The light guide 2′ is rotationally symmetric in respect of the axis of rotational symmetry 300′ of the light output coupling optical unit 3′. The light guide 2′ has a cylindrical embodiment in the region outside of the conically tapered light guide portion 24′. The lateral area 23′ thereof therefore has the corresponding symmetry. The converging lens apparatus 20, which was already described above, is arranged at the light-entrance end 21′ of the light guide 2′.

Various embodiments are not restricted to the embodiments explained in more detail above.

By way of example, in place of the above-described light output coupling optical units, use may be made of a light output coupling optical unit which includes a plurality of frustum-like portions or which consists of only a single cone-like or frustum-like portion.

The light guide and the light output coupling optical unit may have either an integral embodiment or an embodiment as separate components. In various embodiments, the light guide and the light output coupling optical unit may be formed from the same material or may be assembled by means of cement or an adhesive.

Further, the light guide of the retrofit lamp according to various embodiments may have a tapering embodiment in the direction of the light-exit end thereof in order to ensure higher stability and resistance in relation to tremors. In various embodiments, the light guide may have a larger diameter in the region of the light-entrance end thereof than in the region of the light-exit end thereof. In accordance with a further embodiment, the light guide 2 of the retrofit lamp has a conical embodiment in the direction of the light-exit end 22 thereof such that, proceeding from the light-entrance end 21 thereof, the diameter thereof decreases continuously in the direction of the light-exit end 22 thereof, with the diameter being 4.2 mm at the light-entrance end and 3.5 mm at the light-exit end. Furthermore, the light guide 2, 2′ of the retrofit lamp according to various embodiments may be embodied as an optical concentrator and the form thereof may be adapted according to this purpose.

Moreover, the number and type of the semiconductor light sources of the retrofit lamp according to various embodiments may be modified. By way of example, one or more laser diodes may be used in place of the LED chips in the retrofit lamp according to various embodiments. In various embodiments, the light of one or more laser diodes may be coupled into the light guide by means of a converging lens apparatus and may be emitted by way of the light output coupling optical unit, wherein the laser light, e.g. blue laser light, is converted in part into light with a different wavelength by means of a phosphor element in order to produce white light as a mixture of converted light and non-converted laser light. By way of example, the phosphor element is a light-transmissive ceramic disk made of cerium-doped yttrium aluminum garnet (YAG:ce), which is arranged on the light-entrance end 21 of the light guide 2. Alternatively, the phosphor element may also be formed as a coating of the surface of the light guide in the region of the light output coupling optical unit.

Moreover, the retrofit lamp according to various embodiments may also be equipped with semiconductor light sources which emit single colored or multi-colored light in order, for example, to implement a signal-light function such as e.g. braking light or a turn indicator.

Furthermore, the assembly printed circuit board 5 may contain further functional elements, such as e.g. optical sensors, Peltier cooling elements and heating elements which, for example, serve to preheat the LED chips at low temperatures, e.g. temperatures below 0° C.

Further, the lamp vessel 8 of the retrofit lamp according to various embodiments may have a light-opaque coating embodied as an optical stop in order to modify the light distribution of the retrofit lamp. By way of example, the light-opaque coating embodied as an optical stop may be embodied on the lamp vessel in such a way that a light-transmissive window is defined on the surface of the lamp vessel in order to produce a dimmed light distribution. In various embodiments, the form of the light-opaque coating on the lamp vessel 8 embodied as an optical stop may correspond to the form of such a coating on the outer bulb of a high-pressure discharge lamp of ECE category D1R, D2R, D3R, D4R, or D8R such that the retrofit lamp according to various embodiments is usable as a replacement for such a high-pressure discharge lamp in the vehicle headlight.

### LIST OF REFERENCE SIGNS

1 Retrofit lamp

2, 2′ Light guide

21, 21′ Light-entrance end of the light guide

22, 22′ Second end of the light guide

23, 23′ Lateral area of the light guide

20 Converging lens apparatus

200 Holder of the light guide

201, 202 Fastening straps

203 Fastening ring

3, 3′ Light output coupling optical unit

300, 300′ Longitudinal axis or axis of rotational symmetry of the light output coupling optical unit

30 Lateral area of the light output coupling optical unit

301, 301′ First portion of the light output coupling optical unit

302, 302′ Second portion of the light output coupling optical unit

303′ Third portion of the light output coupling optical unit

31, 31′ First end of the light output coupling optical unit

32, 32′ Second end of the light output coupling optical unit

41 LED chip

42 LED chip

410 Light-emitting diode

420 Light-emitting diode

5 Assembly circuit board

50 Components of the operating circuit

6 Base

60 Base housing

61 Base flange

62 Reference plane of the base

63 Perforation in the base housing

7 Cooling body

70 Cooling ribs

8 Lamp vessel

81 End of the lamp vessel

9 Reflector

90 Reflection area

91 Assembly opening of the reflector

900 Optical axis

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A retrofit lamp for vehicle headlights, the retrofit lamp comprising:
at least one semiconductor light source;
a light output coupling optical unit; and
a light guide configured to guide light from the at least one semiconductor light source to the light output coupling optical unit;
wherein the light output coupling optical unit has a light-reflecting embodiment and comprises a first end and a second end;
wherein the first end is arranged closer to the at least one semiconductor light source than the second end; and
wherein the light output coupling optical unit, proceeding from the second end, has a tapering embodiment in the direction of the first end.

2. The retrofit lamp of claim 1,
wherein the light output coupling optical unit has a mirror symmetric embodiment in respect of the plane containing a longitudinal axis of the light output coupling optical unit;
wherein the longitudinal axis extends centrally through the first end and the second end of the light output coupling optical unit.

3. The retrofit lamp of claim 1,
wherein the light output coupling optical unit has a rotationally symmetric embodiment in respect of an axis of rotational symmetry and a minimum diameter at the first end thereof.

4. The retrofit lamp of claim 1,
wherein the light output coupling optical unit comprises at least one portion with a cone-like or frustum-like embodiment and a light-reflecting surface.

5. The retrofit lamp of claim 1,
wherein at least the first end of the light output coupling optical unit is embodied in the material of the light guide.

6. The retrofit lamp of claim 1,
wherein the light output coupling optical unit is formed by a cavity with a funnel-like form in the light guide; and
wherein surfaces delimiting the cavity have a light-reflecting embodiment.

7. The retrofit lamp of claim 1,
wherein the light guide has a rod-like embodiment.

8. The retrofit lamp of claim 2,
wherein the longitudinal axis or axis of rotational symmetry of the light output coupling optical unit corresponds to an axis of longitudinal extent of the light guide.

9. The retrofit lamp of claim 1,
wherein the retrofit lamp comprises a base which defines a reference plane for aligning the light output coupling optical unit.

10. The retrofit lamp of claim 2,
wherein the axis of rotational symmetry of the light output coupling optical unit is aligned perpendicular to the reference plane.

11. The retrofit lamp of claim 9,
wherein the distance between the first end of the light output coupling optical unit and the reference plane is less than a value E and the distance between the second end of the light output coupling optical unit and the reference plane is greater than or equal to the value E, wherein the value E is either 27.1 mm or 18.0 mm.

12. The retrofit lamp of claim 10,
wherein the base comprises a base housing, in which the at least one semiconductor light source is arranged.

13. The retrofit lamp of claim 12,
wherein one end of the light guide is arranged in the base housing.

14. A vehicle headlight, comprising:
at least one retrofit lamp, comprising:
at least one semiconductor light source;
a light output coupling optical unit; and
a light guide configured to guide light from the at least one semiconductor light source to the light output coupling optical unit;
wherein the light output coupling optical unit has a light-reflecting embodiment and comprises a first end and a second end;
wherein the first end is arranged closer to the at least one semiconductor light source than the second end; and
wherein the light output coupling optical unit, proceeding from the second end, has a tapering embodiment in the direction of the first end.

15. The vehicle headlight of claim 14,
wherein the vehicle headlight comprises a reflector with an optical axis and the at least one retrofit lamp is arranged in the vehicle headlight in such a way that the longitudinal axis or axis of rotational symmetry of the light output coupling optical unit of the retrofit lamp lies in the optical axis of the reflector or is arranged with parallel offset to the optical axis of the reflector.
